(19) United States
(12) Patent Application Publication
(10) Pub. No.: US 2018/0242069 A1
(43) Pub. Date: Aug. 23, 2018

(54) Earpiece with tap functionality

(71) Applicant: BRAGI GmbH, Munchen (DE)

(72) Inventors: Nikolaj Hviid, Munchen (DE); Michael Hlatky, Munchen (DE)

(73) Assignee: BRAGI GmbH, Munchen (DE)

(21) Appl. No.: 15/894,288

(22) Filed: Feb. 12, 2018

Related U.S. Application Data
(60) Provisional application No. 62/461,657, filed on Feb. 21, 2017.

(51) Int. Cl. H04R 1/10; H04R 1/04

(52) U.S. Cl. CPC H04R 1/105; H04R 2201/10; H04R 1/1041; H04R 1/04

(57) ABSTRACT

An earpiece comprises an earpiece housing, a digital signal processor disposed within the ear piece housing, and at least one microphone operatively connected to the digital signal processor. The earpiece is configured to receive audio from the at least one microphone and process the audio with the digital signal processor to determine if a user has performed a tap on the earpiece. The earpiece may further include a wireless transceiver disposed within the ear piece wherein the earpiece is configured to communicate data indicative of occurrence of the tap using the wireless transceiver.

### PRIORITY STATEMENT

This application claims priority to U.S. Provisional Patent Application No. 62/461,657, filed Feb. 21, 2017, hereby incorporated by reference in its entirety.

### FIELD OF THE INVENTION

The present invention relates to wearable devices. More particularly, but not exclusively, the present invention relates to earpieces.

### BACKGROUND

Earpieces hold great promise as widely adopted wearable devices. One of the problems with earpieces continue to be limitations on the manner in which user input is provided. What is needed are improved earpieces which allow for receiving user input in an efficient and desirable manner.

### SUMMARY

Therefore, it is a primary object, feature, or advantage of the present invention to improve over the state of the art.

It is a further object, feature, or advantage of the present invention to provide for new ways of receiving user input for ear pieces.

It is a still further object, feature, or advantage of the present invention to provide for new ways of receiving manual input from users.

Another object, feature, or advantage is to receive manual input from a user of an earpiece without needing a touch sensor.

Yet another object, feature, or advantage is to receive manual input from a user without needing manual buttons.

Another object, feature, or advantage of the present invention is to reduce or eliminate false positive indications that taps occurred.

Yet another object, feature, or advantage is to provide for a way for receiving manual input from a user which is easy for a user to use.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

According to one aspect, an earpiece comprises an earpiece housing, a digital signal processor disposed within the ear piece housing, and at least one microphone operatively connected to the digital signal processor. The earpiece is configured to receive audio from the at least one microphone and process the audio with the digital signal processor to determine if a user has performed a tap on the earpiece. The earpiece may further include a wireless transceiver disposed within the ear piece wherein the earpiece is configured to communicate data indicative of occurrence of the tap using the wireless transceiver. The wireless transceiver may include a near field magnetic induction transceiver (NFMI)or a radio transceiver such as a Bluetooth, BLE, or other type of radio transceiver. Multiple transceivers may be present such as one NFMI transceiver and one BLE transceiver. The earpiece may further include a processor disposed within the ear piece housing and a wireless transceiver disposed within the ear piece housing and operatively connected to the processor and wherein the processor is configured to receive data indicative of the tap on the ear piece from the digital signal processor and wherein the processor is configured to receive data indicative of a tap on a different earpiece through the wireless transceiver. The processor may be further programmed to interpret one or more taps on the earpiece and/or one or more taps on the different earpiece as a user command and to perform an action based on the user command. The action may include communicating the user command to another device in operative communication with the earpiece. The earpiece may be configured to receive audio from the at least one microphone and process the audio with the digital signal processor to determine a location of the tap on the earpiece. The at least one microphone may be positioned to face outwards.

According to another aspect, an earpiece includes an earpiece housing, a processor disposed within the ear piece housing, at least one microphone operatively connected to the processor, and a wireless transceiver disposed within the earpiece housing and operatively connected to the processor. The earpiece is configured to receive audio from the at least one microphone and process the audio with the processor to determine if a user has performed a tap on the earpiece. The earpiece may be further configured to interpret user input comprising the tap and perform an action based on the user input. The user input may further include one or more taps on an additional earpiece in operative communication with the earpiece. The user input may include a plurality of taps including the tap. The wireless transceiver may be a radio transceiver.

According to another aspect, a system includes a set of earpieces including a left ear piece and a right ear piece, each of the earpieces comprising an ear piece housing, a digital signal processor disposed within the ear piece housing, at least one microphone operatively connected to the processor, wherein each of the earpieces is configured to receive audio from the at least one microphone and process the audio with the digital signal processor to determine if a user has performed a tap on the earpiece.

According to another aspect, a method for use in a wireless earpiece comprising an earpiece housing, a processor disposed within the earpiece housing, at least one microphone operatively connected to the processor. The method includes receiving user input comprising a physical tap by the user on the earpiece, monitoring audio associated with the user input from the at least one microphone, and processing the audio associated with the user input to determine occurrence of the physical tap. The method may further include performing an action based on the user input.

According to another aspect, an earpiece includes an earpiece housing, a digital signal processor disposed within the ear piece housing, and at least one intelligent microphone operatively connected to the digital signal processor. The earpiece is configured to receive audio from the at least one intelligent microphone and process the audio with the digital signal processor.

### BRIEF DESCRIPTION OF THE DRAWINGS

FIG. 1 illustrates one example of a system or set of earpieces including a left ear piece and a right ear piece with each ear piece having at least one microphone for detecting physical or mechanical user interactions such as taps.

FIG. 2 is a block diagram of one example of an earpiece which may use a microphone for detecting physical or mechanical user interactions such as taps.

FIG. 3 illustrates an audio signal containing two tap events.

### DETAILED DESCRIPTION

An earpiece wearable device may be used to sense acoustic events using one or more microphones of the earpiece, where the acoustic event is created by a mechanical or physical interaction with the device. For example, a user may tap the earpiece housing and the microphone(s) may sense the audio and a processor such as a digital signal processor may then analyze the audio to determine that the acoustic event was a tap. Thus, user input from a user may be sensed as an acoustic event. The user input may be a single tap on one earpiece, multiple taps on the earpiece, or where two earpieces are used (one left earpiece and one right earpiece), the user input may include one or more taps on each of the earpieces. The earpiece may interpret the user input as a command and perform one or more actions based on the command.

The microphone may be of any number of types. For example, the microphone may be a smart microphone or intelligent microphone from Knowles Corporation which integrates an audio processing algorithm with acoustic detection into a multi-mode digital microphones. One of the benefits of such a selection of microphone is that such a device can recognize when the audio should be in sleep mode and when it should be awakened thereby reducing power usage relative to a device which is always on in a battery usage mode.

It should be appreciated that user input in the form of taps may be used to perform any number of functions. These may include to raise or lower volume such as by receiving a tap on one earpiece to raise volume and receiving a tap on a second earpiece to lower volume. These may include receive a double tap to play music or pause music. Note that the use of taps or user input may be context-driven. Thus, while music is playing a double tap may pause the music. If the music is paused or stopped, the double tap may play the music. Similarly, a tap on one earpiece may be used to accept a phone call while a tap on the other earpiece may be used to reject the phone call.

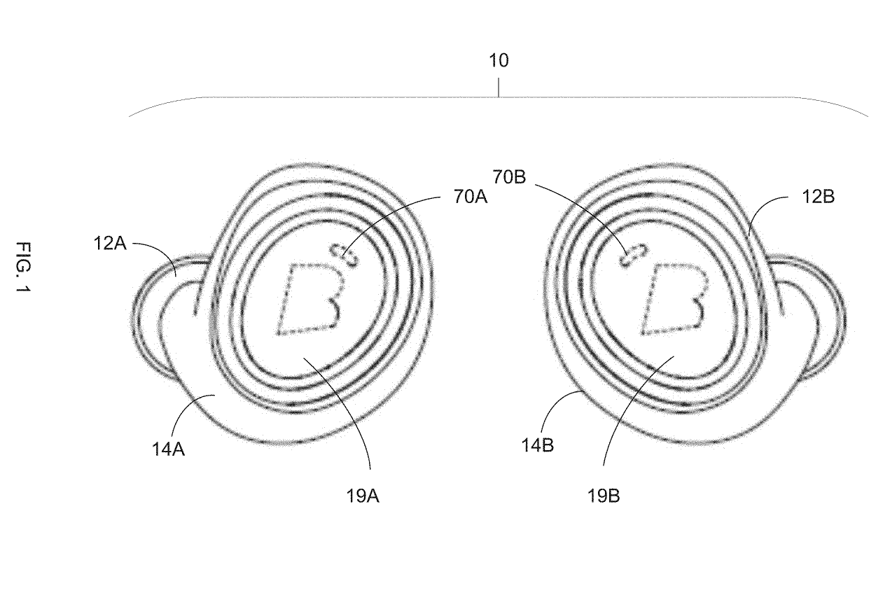

FIG. 1 illustrates one example of a system or set of earpieces 10 which includes include a left earpiece 12A and a right earpiece 12B. Each of the earpieces includes an earpiece housing 14A, 14B. Each earpiece 12A, 12B may include one or more external surfaces on its housing 14A, 14B. Surfaces 19A, 19B are shown. The surfaces 19A, 19B may be used for tapping. Positioned at surfaces 19A, 19B are outward facing external microphones 70A, 70B. The microphones may be of the type previously described, MEMS microphones, or other types of microphones. The microphones may be used to detect acoustical events such as taps or other physical or mechanical interactions between a user and the microphones. In some embodiments, the physical or mechanical interactions may be a user tapping on their ears, temple, or head, or on another item such as glasses or jewelry. It should also be understood that instead of performing a tap directly on the earpiece it is contemplated that the tap may be performed near the earpiece such as at the ear or other location provided the acoustic event associated with the tap can be appropriately analyzed and characterized.

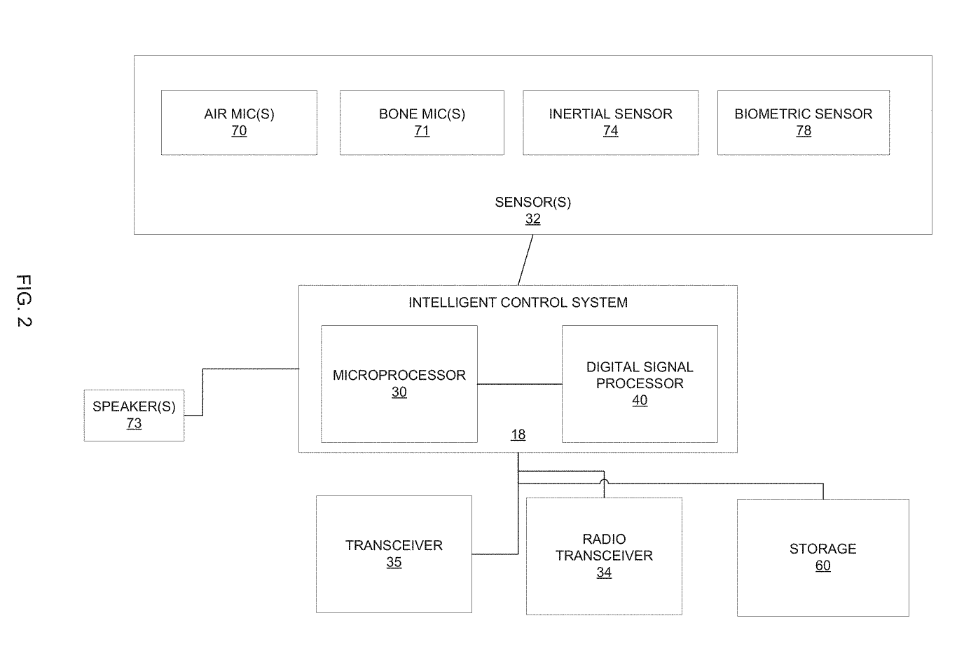

FIG. 2 illustrates one example of a block diagram for a wireless earpiece. As shown in FIG. 2, one or more sensors 32 are present. The sensors 32 may include one or more air microphones 70, one or more bone microphones 71, one or more inertial sensors 74, and one or more biometric sensors 78. The sensors 32 are operatively connected to an intelligent control system 18 which may include one or more processors such as a microprocessor microcontroller 30 and a digital signal processor 40. It is to be understood that inputs shown to the intelligent control system 18 may be in the form of electrical connections to one or both of the microprocessor 30 and the digital signal processor 40. Similarly, outputs shown from the intelligent control system 18 may be in the form of electrical connections from one or both of the microprocessor 30 and the digital signal processor 40.

In one configuration where a digital signal processor 40 is used, the digital signal processor 40 may process an audio signal to analyze an acoustical event. The digital signal processor may be configured to detect, classify, and identify acoustical events as user input in the form of user interactions such as taps. In one implementation, training may be permitted where a user is instructed to perform different actions including performing different physical events such as taps to collect examples of acoustical events. It is to be understood that varying levels of complexity to the processing may be applied if greater discernment in a user's actions are required. For example, if instead of tapping on a surface of the earpiece, tapping in other areas of the ear or head or on other items such as jewelry may require more complexity or computing power to detect, classify, and identify the acoustical event.

One or more speakers 73 are operatively connected to the intelligent control system. In addition, one or more transceivers may be in operative communication with the intelligent control system 18. For example, the transceiver 35 may be a near field magnetic induction (NFMI) transceiver which may, for example, be used to communicate between the earpiece and a second earpiece or other wearable device. The radio transceiver 34 is operatively connected to the intelligent control system 18. The radio transceiver 34 may be a Bluetooth transceiver, a BLE transceiver, a cellular transceiver, a UWB transceiver, a Wi-Fi transceiver, or other type of radio transceiver. Storage 60 is shown which is operatively connected to the intelligent control system 18. The storage 60 may be in the form of flash memory or other memory which may be used for various purposes including storing audio files which may be stored by the device and played back. Thus, for example, music may be played by the device or audio may be recorded by the device and stored locally. Of course, the storage 60 may be used to store other information as well.

As shown in FIG. 2, the earpiece includes a processor such as a digital signal processor 40. The digital signal processor 40 and other components may be disposed within the ear piece housing. There is at least one microphone 70 operatively connected to the digital signal processor 40. The earpiece is configured to receive audio from the microphone(s) 70 and process the audio with the digital signal processor 40 to determine if the user has performed a tap on the earpiece or performed another example of a physical operation or mechanical operation. The earpiece may further include a wireless transceiver (34 and/or 35) disposed within the ear piece wherein the earpiece is configured to communicate data indicative of occurrence of the tap using the wireless transceiver (34 and/or 35). In one embodiment transceiver 35 may be a near field magnetic induction transceiver (NFMI) and a radio transceiver 34 such as a Bluetooth, BLE, or other type of radio transceiver may be present. It is to be understood that where two earpieces are used together as a part of a system each earpiece need not have identical circuitry. For example, the earpieces may have different combinations of sensors. In one embodiment, only one of the earpieces need include a radio transceiver 34 as the other earpiece may communicate with it using a transceiver 35. The intelligent control system 18 which may be a processor, a combination of processors, FPGAs, microcontrollers, and/or digital signal processors may be configured to receive data indicative of the tap on the ear piece and may also be configured to receive data indicative of a tap on a different earpiece through the wireless transceiver. The intelligent control system 18 may be further programmed to interpret one or more taps on the earpiece and/or one or more taps on the different earpiece as a user command and to perform an action based on the user command. The action may include communicating the user command to another device such as a phone, tablet, or another wearable device in operative communication with the earpiece.

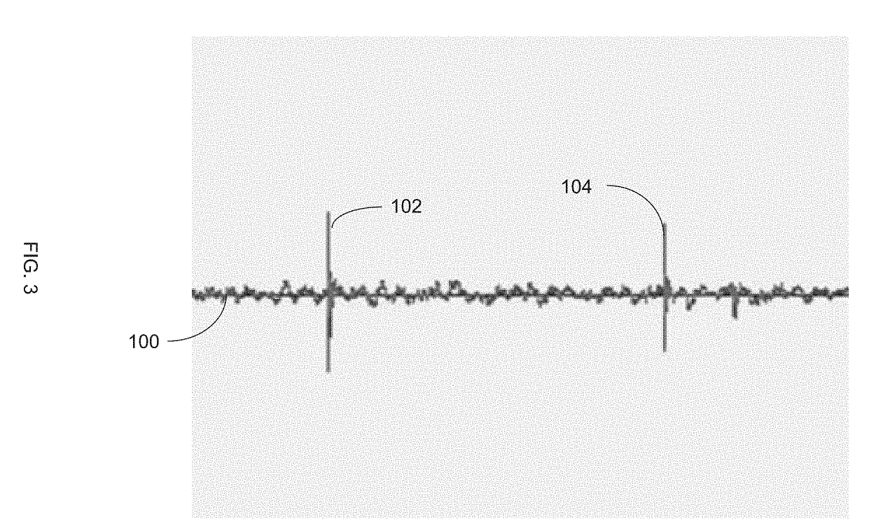

FIG. 3 illustrates an audio signal 100 from a microphone. A first waveform 102 is associated with a first tap on a wireless earpiece. A second waveform 104 is associated with a second tap on the wireless earpiece. Any number of audio processing algorithms may be used to detect the presence of one or more taps including audio event classification and detection algorithms. It is to be further understood that to assist with the determination of whether a tap has occurred, additional data may be combined with the analysis of the audio signal to reduce the likelihood of a false positive.

For example, a determination may be made as to whether contextual data is indicative that a user is likely or more likely to communicate with a tap. For example, if the wireless earpiece has just prompted the user with a voice prompt, it may be more likely that a user will communicate with one or more taps. Similarly, if the user has just inserted the wireless earpiece into the ear, it may be more likely that the user will communicate with one or more taps. The determination as to whether a user has just inserted the earpiece may be made based on inertial data, contact sensors, optical sensors, or otherwise.

By way of further example, inertial sensor data may be further used to assist in verifying that a user has performed a tap on the wireless earpiece. For example, an inertial signal may be correlated with the audio signal at the time of the tap to confirm the occurrence of a tap.

It is further to be understood that multiple microphone signals may be used in determining whether a tap has occurred or not, including multiple microphones present at the wireless earpiece. The use of multiple microphones and their respective positions relative to a surface for tapping, may be further be used to increase the likelihood of determining that a tap has occurred while reducing the likelihood of false positive events.

Therefore, an earpiece, system of earpieces, and associated methods have been shown and described. Although specific embodiments and examples have been shown and described, the present invention is not to be limited to any specific embodiments. In particular, options, variations, and alternatives are contemplated including in the specific structure, components, interactions between the components, number of microphones, types of microphones, type of processor(s) including digital signal processors, microprocessors, and or other types of processors, the shape or configuration of the earpiece housing, algorithms for performing analysis, whether the earpieces are integrated into a headset, the type of physical interaction with the earpieces, and other options, variations, and alternatives.

What is claimed is:

1. An earpiece comprising:
an earpiece housing;
a digital signal processor disposed within the ear piece housing;
at least one microphone operatively connected to the digital signal processor;
wherein the earpiece is configured to receive audio from the at least one microphone and process the audio with the digital signal processor to determine if a user has performed a tap on the earpiece.

2. The earpiece of claim 1 further comprising a wireless transceiver disposed within the ear piece wherein the earpiece is configured to communicate data indicative of occurrence of the tap using the wireless transceiver.

3. The earpiece of claim 2 wherein the wireless transceiver is a near field magnetic induction transceiver.

4. The earpiece of claim 2 wherein the wireless transceiver is a radio transceiver.

5. The earpiece of claim 1 further comprising a processor disposed within the ear piece housing and a wireless transceiver disposed within the ear piece housing and operatively connected to the processor and wherein the processor is configured to receive data indicative of the tap on the ear piece from the digital signal processor and wherein the processor is configured to receive data indicative of a tap on a different earpiece through the wireless transceiver.

6. The earpiece of claim 5 wherein the processor is further programmed to interpret one or more taps on the earpiece and/or one or more taps on the different earpiece as a user command and to perform an action based on the user command.

7. The earpiece of claim 6 wherein the action comprises communicating the user command to another device in operative communication with the earpiece.

8. The earpiece of claim 1 wherein the earpiece is configured to receive audio from the at least one microphone and process the audio with the digital signal processor to determine location of the tap on the earpiece.

9. The earpiece of claim 1 wherein the at least one microphone is positioned to face outwards.

10. The earpiece of claim 1 further comprising a surface for tapping on an outer portion of the earpiece housing.

11. The earpiece of claim 11 wherein at least one of the microphones is positioned at the surface.

12. An earpiece comprising: an earpiece housing;
a processor disposed within the ear piece housing;
at least one microphone operatively connected to the processor;
a wireless transceiver disposed within the earpiece housing and operatively connected to the processor;
wherein the earpiece is configured to receive audio from the at least one microphone and process the audio with the processor to determine if a user has performed a tap on the earpiece;
wherein the earpiece is configured to interpret user input comprising the tap and perform an action based on the user input.

13. The earpiece of claim 12 wherein the user input further comprises one or more taps on an additional earpiece in operative communication with the earpiece.

14. The earpiece of claim 13 wherein the user input further comprises a plurality of taps including the tap.

15. The earpiece of claim 12 wherein the wireless transceiver is a radio transceiver.

16. The earpiece of claim 12 further comprising an inertial sensor operatively connected to the processor and wherein the processor is configured to correlate the audio with inertial sensor data from the inertial sensor in determining if the user has performed the tap on the earpiece.
